(19) United States
(12) Patent Application Publication
(10) Pub. No.: US 2005/0279780 A1
(43) Pub. Date: Dec. 22, 2005

(54) Switch mode gun driver and method

(76) Inventors: Howard Evans, Sugar Hill, GA (US); Roger B. Fell, Avon Lake, OH (US)

Correspondence Address: WOOD, HERRON & EVANS, LLP (NORDSON), 2700 CAREW TOWER, 441 VINE STREET, CINCINNATI, OH, 45202, US

(21) Appl. No.: 11/113,959

(22) Filed: Apr. 25, 2005

Related U.S. Application Data
(60) Provisional application No. 60/567,264, filed on Apr. 30, 2004.

(51) Int. Cl. B67B 7/00; G01F 11/00; B67D 3/00; B67D 5/06

(52) U.S. Cl. 222/504

(57) ABSTRACT

Driver circuits for a fluid dispenser operable to dispense a fluid onto a substrate. One driver circuit uses high and low voltage busses to provide a quick pull-in current. Flyback current during a transition to a hold current is clamped to the high voltage bus to return energy to the high voltage bus, which is a capacitor. Another driver circuit uses transitional current references to control coil current at the initial pull-in transition and at the transition from pull-in to hold. In the transition from pull-in to hold, the flyback coil current is modulated between a flyback mode and a freewheel mode.

This application claims the benefit of U.S. application Ser. No. 60/567,264, filed on Apr. 30, 2004, there entirety of which is incorporated by reference herein.

### FIELD OF THE INVENTION

The present invention relates generally to fluid dispensing systems for dispensing flowable material, such as adhesives, sealants, caulks and the like, onto a substrate and, more particularly, to a driver circuit for controlling an operation of a solenoid-actuated valve within a dispensing gun.

### BACKGROUND OF THE INVENTION

Fluid dispensing guns have been developed for dispensing applications requiring a precise placement of a fluid, for example, an adhesive, onto a moving substrate, for example, packaging or a woven product. One example of such a dispensing system is set forth in U.S. Pat. No. 5,812,355, the entirety of which is hereby incorporated by reference herein. Such a dispensing system employs a driver circuit to control the operation of the solenoid within the fluid dispenser. A stepped current waveform as shown in FIG. 9 is used to control the operation of a dispensing valve within the dispenser. To open the valve, the driver circuit applies a fast initial slope 38 of a pull-in current 80 to the solenoid coil to quickly retract the valve stem and open a dispensing orifice at the beginning of a dispensing cycle. Thereafter, the current is stepped down at 37 to a hold current 40 that holds the valve stem in an open position. The hold current is less than the pull-in current; and therefore, use of the lesser hold current reduces the build-up of heat in the solenoid coil and dispensing valve during the dispensing cycle. The driver circuit then provides a fast demagnetization of the solenoid at 42, so the valve stem is quickly closed over the orifice at the end of the dispensing cycle.

While a gun driver as described above performs well, there is a continuing effort to improve its performance. For example, often, current to the coil is supplied by the power switch from the line voltage. Thus, any variations in line voltage changes the output voltage from the power circuit and the current being supplied to the gun solenoid. Consequently, if the magnitude of the line voltage goes up, the armature moves faster; and the adhesive is dispensed too soon. Similarly, if the magnitude of the line voltage goes down, the armature moves slower; and the adhesive is dispensed longer than expected. Any unpredicted dispensing of adhesive onto an area of a substrate not intended to receive adhesive often results in a scrap product.

The maximum speed of operation of the dispensing valve is determined by the voltage magnitude of the line voltage. Therefore, a dispensing valve connected to a 240 Volt AC source will operate faster than if it were connected to a 120 Volt AC source. Thus, there is a need to provide a driver circuit that has a consistent, high speed operation independent of the line voltage.

With a known gun driver, the pull-in current 80 and hold current 40 are often maintained by a hysteresis modulator operating a power switch, thereby producing a sawtooth or ripple current in the solenoid coil. During this modulation of the power switch, when the switch is closed, the rate of current increase in the coil is determined by the magnitude of the line voltage; and the modulation current ramps up as shown at 39 in FIG. 9. Further, when the power switch is closed, the current decays at a rate determined by the coil inductance and the coil circuit resistance as shown at 41 in FIG. 9. Therefore, the frequency of the hysteresis modulation is determined and limited by the current flow characteristics in the solenoid coil and the line voltage. While, it may be desirable to use a higher line voltage to increase the operational speed of the dispensing valve, such higher line voltage produces an increased current overshoot during periods of current modulation, thereby increasing the heat in the coil and hence, the dispensing valve. Thus, there is a further need to provide a gun driver that maximizes the operational speed of the dispensing valve while minimizing the heat added to the coil.

As will be appreciated, the waveforms illustrated in FIG. 9 as well as in other figures herein are for purposes of discussion. The real waveforms may look quite different from the idealized waveforms shown in the figures herein depending on many factors, including but not limited to, the inductance and resistance of the coil, the requirements of a dispensing pattern, thermal considerations, parasitic capacitance, etc.

With a known gun driver, when the current is in transition from the pull-in current to the hold current as shown at 168 of FIG. 2, current in the coil created from the back EMF of the collapsing magnetic field decays at a rate determined by the coil inductance and the solenoid coil circuit resistance. The slew rate of such a current decay is relatively slow, and the current is dissipated as heat in the coil circuit resistance. Thus, there is also a need to provide a gun driver that more effectively utilizes current in the coil resulting from a collapse of the magnetic field in the coil during a transition from the pull-in current to the hold current and upon the removal of power from the coil.

It is also known to use the gun driver to operate a plurality of dispensing valves. If those dispensing valves are connected in series, it is desirable to operate the gun driver in a current control mode to better control current in the series connected solenoid coils. However, if those dispensing valves are connected in parallel, it is desirable to operate the gun driver in a voltage mode control to better control the voltage applied across the parallel circuit of solenoid coils. With known systems, a voltage mode control requires a gun driver that is of a different design from a gun driver used to effect a current mode control. Thus, there is a need to provide a gun driver that can be selectively used to provide either a voltage mode control or a current mode control.

Therefore, there is a need to provide a gun driver that addresses the needs described above.

### SUMMARY OF INVENTION

The present invention provides gun drivers for a fluid dispensing gun that execute a stable, consistent and high quality fluid dispensing process independent of line voltage variations. Further, the gun drivers of the present invention are operable to open the dispensing valve at a consistent, predictable, high speed. In addition, with the gun drivers of the present invention, during a transition from a pull-in current to a hold current, the flyback current of the coil is stored for subsequent use and is not dissipated as heat as is done in known systems. Thus, the gun drivers of the present invention provide a consistent and predictable dispensing gun performance in a wide range of applications while operating with less power loss and reducing self-heating. By reducing heat generated from power losses, not only is dispensing gun life increased, but higher operating currents may be used to increase performance.

One of the gun drivers of the present invention can be selectively used in either a current control mode or a voltage control mode depending on whether a plurality of solenoid coils is connected in series or parallel with respect to a voltage bus. When in the current control mode, a low voltage bus is used to provide a highly regulated, low amplitude ripple current for maintaining the pull-in current and the hold current, thereby reducing energy consumption, heat in the dispensing valve and electromagnetic radiation. When in the voltage control mode, the power switching circuit is pulse width modulated independent of a current feedback signal.

According to the principles of the present invention and in accordance with the described embodiments, the invention provides a gun driver circuit for a fluid dispenser operable to dispense a fluid onto a substrate. The fluid dispenser has a solenoid coil operating a dispensing valve to control a flow of the fluid from the fluid dispenser. The gun driver has a first switch connected between a higher voltage bus and one end of the solenoid coil and a second switch connected to an opposite end of the solenoid coil. A current sensor is connected to the second switch, and a third switch is connected between the lower voltage bus and the one end of the solenoid coil. A control circuit closes the first switch to apply the higher voltage bus to the solenoid coil and produce a current in the solenoid coil and then, opens the first switch in response to the current in the coil being substantially equal to the pull-in current setpoint. The control circuit operates the second switch to apply the lower voltage bus to the solenoid coil and maintain the current in the coil substantially equal to the pull-in current setpoint.

In another embodiment of the invention, the gun driver operates with a plurality of fluid dispensing guns operable to dispense a fluid onto a substrate. The fluid dispensing guns has a respective plurality of dispensing valves operably connected to a respective plurality of solenoid coils. Each of the solenoid coils is operable to cause a respective dispensing valve to move between open and closed positions for controlling a flow of the fluid from a respective fluid dispensing gun. The gun driver has a power switching circuit connected between the voltage bus and at least one solenoid coil, and a controller operatively connected to the power switching circuit to cause the power switching circuit to supply a pull-in current to the plurality of solenoid coils followed by a hold current. The controller has a voltage mode control that is used in response to the plurality of solenoid coils being connected in parallel across the voltage bus, and a current mode control that is used in response to the plurality of solenoid coils being connected in series with the voltage bus.

In one aspect of this invention, the current mode control has a current sensor operatively connected with the plurality of solenoid coils to provide a feedback signal representing current in the plurality of solenoid coils. A comparator having a hysteresis value has a first input connected to the feedback signal and a second input providing a current setpoint. A comparator output is connected to the power switching circuit, and the comparator causes the power switching circuit to first, connect the voltage bus to the plurality of solenoid coils in response to the feedback signal being less than the current setpoint and second, disconnect the voltage bus from the plurality of solenoid coils in response to the feedback signal being greater than the current setpoint.

In other aspect of this invention, the voltage mode control has a pulse generator operatively connected to the power switching circuit, the pulse generator causes the power switching circuit successively connect and disconnect the voltage bus to the plurality of solenoid coils after the duration of the pull-in current.

In a further embodiment of the invention, the gun driver has a rectified, unregulated voltage bus and a first switching circuit connected between the unregulated voltage bus and the solenoid coil. A control circuit is operatively connected to a current sensor and the first switching circuit and includes a waveform generator providing a current reference waveform defining a ramp-up current reference, a pull-in current reference and a subsequent hold current reference. The control circuit operates the first switching circuit to create a current in the solenoid coil substantially equal to the ramp-up current reference and then, the pull-in current reference and thereafter, the hold current reference.

In one aspect of this invention, the waveform generator further provides a ramp-down current reference between the pull-in current reference and the hold current reference. A second switching circuit is connected to an opposite end of the solenoid coil and has a first state connecting a flyback current to the unregulated voltage bus in response to the first switching circuit disconnecting the solenoid coil from the unregulated voltage bus. The second switching circuit has a second state allowing the current in the solenoid coil to dissipate through a resistance in a circuit including the solenoid coil. The control circuit switches the second switching circuit between the first state and the second state to cause the current in the coil to be substantially equal to ramp-down current reference.

Various additional advantages, objects and features of the invention will become more readily apparent to those of ordinary skill in the art upon consideration of the following detailed description of embodiments taken in conjunction with the accompanying drawings.

### BRIEF DESCRIPTION OF DRAWINGS

FIG. 1 is a schematic block diagram of a gun driver that may be used to operate a fluid dispensing gun in accordance with the principles of the present invention.

FIG. 2 is a schematic diagram of a current mode waveform provided by the gun driver of FIG. 1.

FIG. 3 is a schematic diagram of one embodiment of a voltage mode waveform provided by the gun driver of FIG. 1.

FIG. 4 is a schematic diagram of another embodiment of a voltage mode waveform provided by the gun driver of FIG. 1.

FIGS. 5A and 5B are schematic block diagrams of another embodiment of a gun driver that may be used to operate a fluid dispensing gun in accordance with the principles of the present invention.

FIG. 6 is a schematic diagram of a current waveform and a resulting coil current waveform provided by the gun driver of FIGS. 5A and 5B.

FIG. 7 is a schematic diagram of a current waveform during a ramp-up phase provided by the gun driver of FIGS. 5A and 5B.

FIG. 8 is a schematic diagram of a current waveform during a ramp-down phase provided by the gun driver of FIGS. 5A and 5B.

FIG. 9 is a schematic diagram of a stepped current waveform provided by a known gun driver.

### DETAILED DESCRIPTION OF THE INVENTION

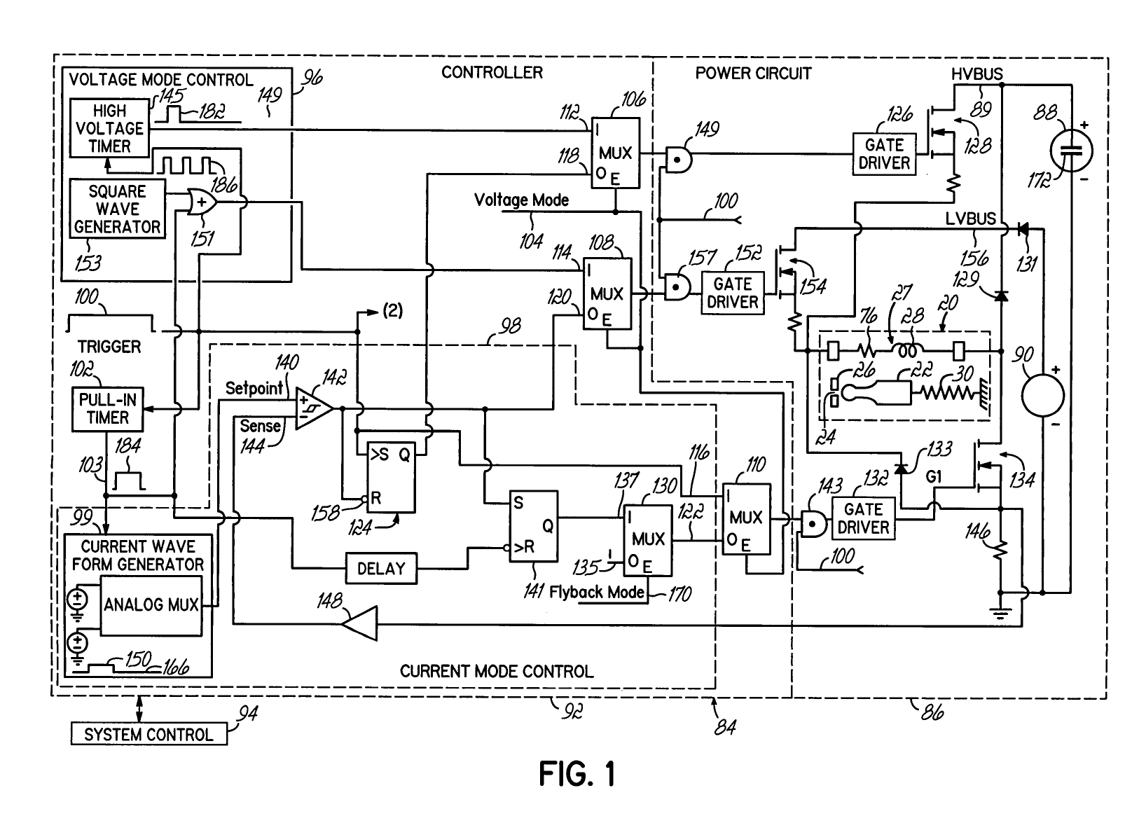

Referring to FIG. 1, a dispensing valve 20 has a movable armature or valve stem 22 positioned to selectively obstruct a dispensing orifice 24 formed in a valve seat 26. The valve stem 22 is extended and retracted relative to the valve seat 26 in a controlled manner by a solenoid 27 having an electromagnetic coil 28 for providing repeatable dispensing patterns of the fluid onto a moving substrate. Generally, the electromagnetic coil surrounds a magnetic pole (not shown) and is energized to produce an electromagnetic field with respect to the magnetic pole, thereby moving the valve stem 22 toward the pole and opening the dispensing valve 20. At the end of a dispensing cycle, the coil 28 is de-energized, and a return spring 30 returns the valve stem 22 to its original position, thereby closing the dispensing valve 20. The coil 28 of the solenoid 27 is operated by a gun driver 84 that includes a power circuit 86 and a controller 92. The power circuit 86 has a high-voltage power supply 88 that provides a high voltage bus 89 of about 325 Volts on a positive terminal.

The power circuit 86 is operated by a controller 92 that, in turn, is connected to a system control 94. The system control 94 includes all of the other dispensing system and machine controls necessary for the operation of the dispensing valve 20, for example, a pattern controller providing a trigger signal, etc. The system control 94 further includes input devices such as a key pad, pushbuttons, etc. and output devices such as a display, indicator lights, etc., that provide communication links with a user in a known manner.

The controller 92 further includes a voltage mode control 96 and a current mode control 98. Depending on whether multiple dispensing valves are connected in parallel or in series, the voltage mode control 96 or current mode control 98, respectively, is selected by a voltage control signal 104. The voltage control signal is created by the system control 94, either automatically or via a user input. In either mode, a fluid dispensing cycle is initiated by a trigger signal 100 having a duration equal to the desired duration of the fluid dispensing cycle, that is, the length of time the dispensing valve 20 is to be turned on or open. A leading edge of the trigger signal 100 starts the operation of a pull-in timer 102 that, in turn, provides an output pulse to the current mode control 98 and the voltage mode control 96. If the voltage mode control 96 is selected, a voltage mode signal on line 104 goes high and enables the multiplexers 106, 108, 110 to pass the signals on their respective inputs 112, 114, 116 to their respective outputs. If the current mode control is selected, the signal on line 104 goes low; and the multiplexers 106, 108, 110 are operative to pass signals on their respective inputs 118, 120, 122 to their respective outputs.

If the user has chosen the current mode control, a pull-in timer 102 in the controller 92 is started by a leading edge of the trigger signal 100 from the system control 94, which indicates a start of a fluid dispensing operation. The duration counted by the pull-in timer 102 determines the duration of the pull-in phase of the operation of the dispensing valve 20. The positive leading edge of the trigger signal 100 simultaneously sets a flip-flop 124 that provides a high output to the input 118 of multiplexer 106. In the current mode control, the multiplexer 106 passes the high output from the flip-flop 124 to a gate driver 126 that causes a first power switch 128 to close. Closing the power switch 128 connects the high voltage bus 89 to one end of the dispensing valve coil 28. Simultaneously, with the flyback mode signal low, the multiplexer 130 passes a high level to the input 122 of multiplexer 110 that, in turn, passes a high level to a second gate driver 132 that functions to close a second power switch 134. With the power switches 128 and 134 closed, a current path exists from the high voltage bus through the first power switch 128, the dispensing valve coil 28 and the second power switch 134.

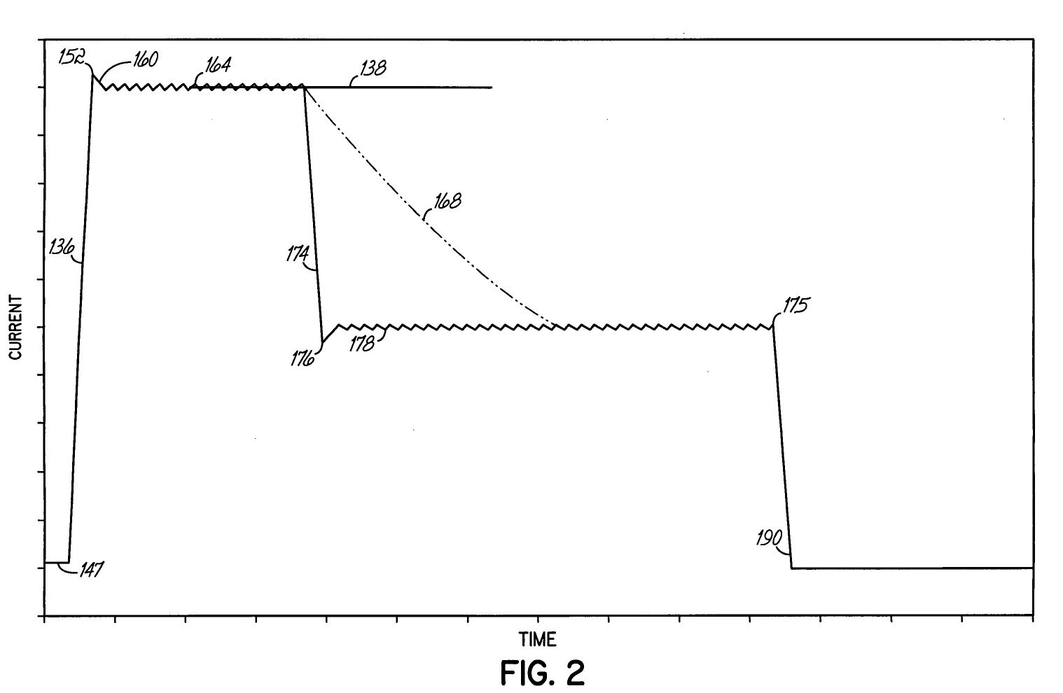

Upon the pull-in timer 102 providing a high signal on output 103 to a current waveform generator 99, the current waveform generator 99 provides a pull-in current setpoint 150 to input 140 of comparator 142 having a hysteresis value. At this time, current flow is minimal as shown at 147 of FIG. 2; and the current feedback signal on input 144 is less than the pull-in current setpoint 150. Thus, the output of the comparator 142 is high. That high signal passes to input 120 of multiplexer 108 and to the gate driver 152, which turns on the first power switch 154.

Thus, to initiate a pull-in current in the current mode, the leading edge of the trigger signal 100 causes the power switches 128, 134 and 154 to close, thereby applying about 325 Volts from the high voltage bus 89 to the solenoid coil. The application of the high voltage bus across the coil 28 provides a maximum rate of current change and a very high pull-in current slew rate as shown at 136 in FIG. 2. The high slew rate of the pull-in current causes current flow in the coil 28 to consistently reach a desired pull-in current level 138 very quickly and predictably. The speed with which the solenoid 27 is able to move the valve stem 22 is determined by the magnetic force generated by the solenoid coil 28, which in turn is determined by the current in the coil. Thus, the faster the coil current reaches its desired pull-in value; the faster the magnetic field will be able to generate a force sufficient to move the valve stem; and the faster the valve stem will be moved to an open position. Therefore, the use of the high voltage bus 89 to provide a fast, consistent and predictable increase in current in the solenoid coil greatly facilitates a fast, consistent and predictable opening of the dispensing valve 20.

As current in the dispensing valve solenoid coil 28 increases, a voltage across a current sensing resistor 146 also increases. That voltage, which represents a feedback current value, is provided to a sense or second input 144 of the comparator 142. Depending on the circuit design, an amplifier 148, which has an adjustable gain to provide current scaling and an absolute current value output, may optionally be used to supply a current feedback signal to the comparator 142. As the pull-in current 136 (FIG. 2) in the coil 28 increases, it will reach a value greater than the pull-in current setpoint 150. Further, due to propagation delays in the components of the gun driver 84, the pull-in current 136 will overshoot the pull-in current setpoint value as shown at 152 in FIG. 2.

When the current feedback on the sense input 144 exceeds a magnitude equal to the pull-in setpoint on input 140 plus the hysteresis value, the comparator 142 switches its output low. That low signal is inverted on a reset input 158 of the flip-flop 124, thereby changing the output of flip-flop 124 to a low state. The flip-flop 124 stays reset throughout the remainder of the dispensing cycle. That low state on input 118 of multiplexer 106 is passed to the gate driver 126, thereby opening the switch 128 and the connection between the high voltage bus 89 and the dispensing valve coil 28. The low state of the comparator 142 is also passed through multiplexer 108, thereby causing gate driver 152 to open the power switch 154 connected to the low voltage bus 156. Current now flows through diode 133, the coil resistance 76, the solenoid coil 28 and the feedback resistor 146. As the energy stored in the coil 28 dissipates and the current decreases, the magnitude of the feedback current on sense input 144 begins to drop. When it drops below a magnitude equal to the pull-in current setpoint 150 on the input 140 minus the hysteresis value, the comparator 142 again changes state, thereby driving its output high. That high state passes through multiplexer 108 and causes gate driver 152 to close the power switch 154, thereby connecting the coil 28 to the low voltage bus 156.

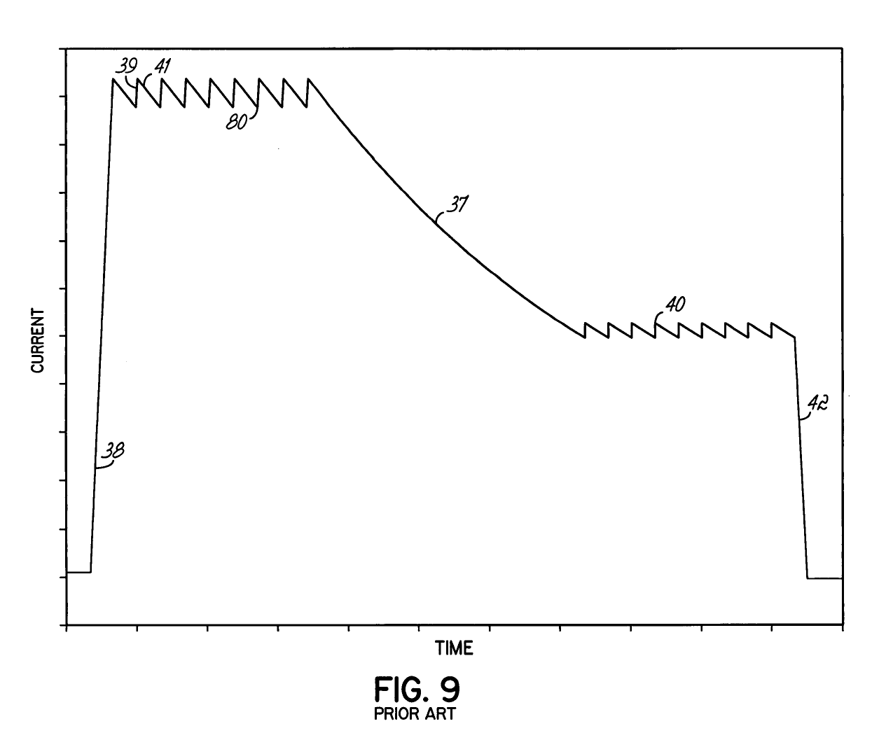

The comparator 142 thus functions as a hysteresis modulator and creates a generally sawtooth or ripple current amplitude 164 (FIG. 2) determined by the hysteresis level of the comparator 140 and the positive slew rate and negative decay rate of the current. The use of the lower voltage bus 156 results in substantially less overshoot and produces a modulation current amplitude 164 (FIG. 2) that is substantially less than the modulation current amplitude 80 (FIG. 9) produced by using a line voltage in known gun drivers. The more highly regulated ripple current has a lower ripple current amplitude that results in less RMS current and less heat generation in the load. Less heat generation provides for an increased life and/or increased performance of the dispensing valve 20 by increasing average current levels. The reduced slew rate and lower ripple will also reduce electromagnetic emissions.

The end of the pull-in time is determined by the timing out of the pull-in timer 102, which changes the state of its output 103. At that point, the current waveform generator 99 reduces the magnitude of the setpoint on input 140 to a lower hold current value 166. Further, the current feedback voltage on input 144 is higher than the hold current value 166; and therefore, the output state of the comparator 142 is low. That low state causes the gate driver 152 to open the power switch 154, thereby disconnecting the low voltage bus from the coil 28.

At the end of the pull-in mode, the gun driver 84 can now be operated in either a freewheel or coast mode in which energy in the coil is dissipated by the coil circuit, or in a flyback mode in which energy in the coil is returned to the power supply. The freewheel mode of operation is selected by the system control 94 switching the state of the flyback mode signal 170 low. The high state on input 135 of multiplexer 130 is passed to multiplexer 110. In the current mode control, the trigger signal high state causes switch 134 to remain closed. In this coast mode of operation, the current in the coil 28 created from the back EMF of the collapsing magnetic field decays at a rate determined by the inductance of the coil 28, the coil resistance 76 and the resistance of the forward voltage across the diode 133, as shown in phantom at 168 in FIG. 2. The slew rate of such a current decay is relatively slow, and the energy is dissipated as heat in the resistor 76 and the diode 133.

In an alternative, flyback mode of operation, as selected by the user or by the system control 94, the flyback mode on enable input 170 is switched to a high state and is applied to enable input 137 of the multiplexer 130. Further, a falling edge created by a timing out of the pull-in timer 102 resets flip-flop 141, which causes the outputs of multiplexers 130 and 110 to go low and further causes the second gate driver 132 to open the second power switch 134. By opening the switch 134, the collapsing magnetic field of the coil 28 induces a current therein that is effective to apply a charge to a capacitor 172 within the high voltage power supply 88 via a path through diodes 129, 133. In this situation, with the flyback voltage clamped to the high voltage bus 89, the current slew rate is very rapid as shown at 174 in FIG. 2; and by charging the capacitor 172, power is returned to the high voltage power supply 88 for subsequent use, thereby reducing power losses in the dispensing valve 20.

Further, current in the coil 28 drops very quickly to a value less than a desired hold current value 175 of FIG. 2. Again, an undershoot 176 occurs due to propagation delays in the components of the gun driver 84. When the current feedback on sense input 144 of comparator 142 falls to a magnitude equal to the hold current setpoint value on input 140 minus the hysteresis value, the comparator 142 again switches its output to a high state. That edge transition sets an output of the flip-flop 141 high, thereby causing the gate driver 132 to again close switch 134. The high state of the output of the comparator 142 is passed by multiplexer 108 to gate driver 152, thereby closing switch 154 and again applying the low voltage bus 156 to the dispensing valve coil 28. The comparator 142 again operates as a hysteresis modulator and continues to switch the power switch 154 on and off to provide the sawtooth or ripple current 178 during the remainder of the hold current phase. In a manner as previously described with respect to the pull-in current phase, the smaller amplitude ripple current 178 provides the advantages of reduced heat, lower electromagnetic emissions and increased life of the dispensing valve.

The end of the dispensing cycle is determined by the trailing edge of the trigger signal 100. When the trigger signal changes state, that edge transition passes through AND gates 149, 157, 143, driving their outputs low. That low state causes the respective power switches 128, 154, 134 to open, thereby disconnecting the high and low voltage busses 89, 156 from the coil 28. With the power switch 134 open, the flyback voltage is clamped to the high voltage bus 89 via diodes 129, 133; and most of the remaining energy in the coil 28 is rapidly dissipated as shown at 190 by charging the capacitor 172 of the high voltage power supply 88. Again, the power returned to the power supply 88 is not converted into heat. By reducing the power losses in the dispensing valve, its life is increased; and the reduced heat permits an increase in operating current to further improve its performance.

As an alternative to the current mode control, the user may choose to operate the gun driver 84 with the voltage mode control 96, which is often used when solenoid coils of respective dispensing valves 20 are connected in parallel. There are two modes of operation with the voltage mode control 96, that is, a first operation mode that does not use the high voltage bus 89 and a second operation mode that does use the high voltage bus. The voltage control mode operation that does not use the high voltage bus 89 will first be described. The system control 94 first switches the state of the voltage mode control signal 104 high, thereby causing multiplexers 106, 108, 110 to pass the states of their respective inputs 112, 114, 116 to their respective outputs.

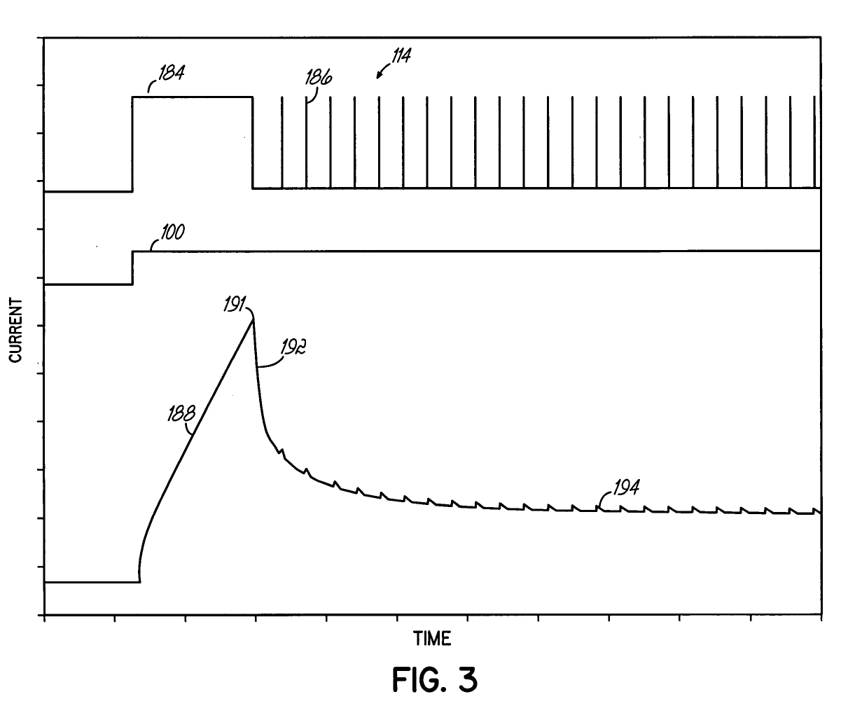

The leading edge of the trigger signal 100 is effective to start the pull-in timer 102, thereby switching its output high. The high state of the trigger signal 100 is passed by multiplexer 110 to gate driver 132, thereby closing power switch 134. Without the high voltage timer operating, AND gate 149 has a continuous low input, thereby maintaining the power switch 128 open. An OR gate 151 has one input connected to the pull-in timer output 103 and a second input connected to a programmable square wave generator 153 providing a square waveform 186. Multiplexer 108 passes that high signal to gate driver 152, thereby closing the switch 154 and applying the low voltage bus 156 to the solenoid coil 28. Thus, current builds up in the solenoid coil 28 as a function of the coil inductance and the resistance in the coil circuit as shown by the current 188 of FIG. 3.

When the pull-in timer 102 times out, and its output 103 goes low, the current in the solenoid coil 28 reaches its peak value as shown at 191 in FIG. 3. With the flyback mode off, when the pull-in pulse 184 goes low, if the output of the square wave generator 153 is also low, input 114 of multiplexer 108 is low, thereby opening power switch 154. Thus, the solenoid coil 28 current dissipates in a freewheel mode in a manner as previously described.

Immediately after the end of the pull-in pulse 184, the OR gate 151 begins to pass the square wave hold pulses 186 from the square wave generator 153. With a leading edge of each of the hold pulses 186, the output of AND gate 157 goes high, which causes the driver 152 to switch the power switch 154 on, thereby reconnecting the dispensing valve coil 28 to the low voltage bus 156 until the trailing edge of the hold pulse goes low. In essence, while current in the coil 28 is decaying as shown at 192, the power switch 154 is pulse width modulated by the hold pulses 186. Eventually, the current in the coil 28 decays to an average current value that is being provided by the pulse width modulation of power switch 154 by the hold pulses 186 as shown at 194 of FIG. 3. The magnitude of the average hold current 194 can be increased or decreased by respectively increasing or decreasing the duty cycle of the hold pulses 186.

The end of the dispensing cycle is determined by the trailing edge of the trigger signal 100; and as previously described, when the trigger signal changes state, AND gates 149, 157, 143 disable respective power switches 128, 154, 134. In a manner previously described, with the power switch 134 open, the flyback voltage is clamped to the high voltage bus 89 via diodes 129, 133; and the dissipating current in the coil 28 is returned to the high voltage power supply 88 for subsequent use.

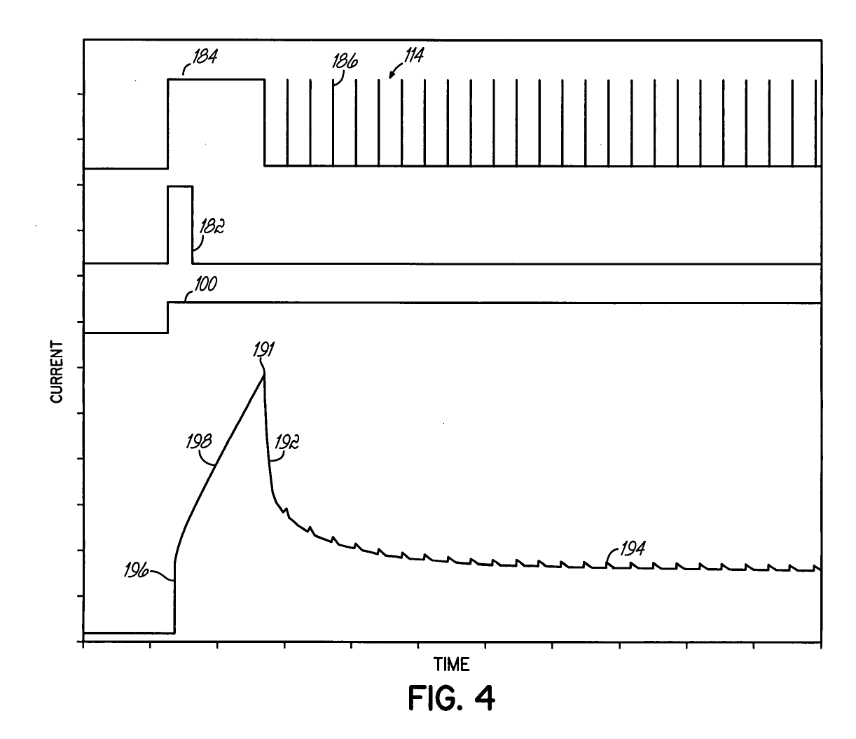

In a second embodiment of the voltage mode control that uses the high voltage bus 89, the high voltage timer 145 is started with the leading edge of the trigger pulse 100 and provides a high voltage pulse 182. The duration of the high voltage pulse 182 can be set to any desired value and is operative over a portion of the duration of the pull-in pulse 184 or the whole duration of the pull-in pulse. The high voltage pulse 182 is input to AND gate 149, thereby driving its output high. That high output causes gate driver 126 to close power switch 128, thereby applying the high voltage bus to the solenoid coil 28. Current rises quickly in the solenoid coil 28 as shown at 196 in FIG. 4. The duration of the high voltage pulse 182 is determined to maximize the performance of the dispensing valve 20. The high voltage pulse 182 subsequently goes low, thereby causing the output of AND gate 149 to go low. That low state passes through multiplexer 106 and causes the gate driver 126 to open the power switch 128, thereby disconnecting the high voltage bus 89 from the solenoid coil 28. The pull-in pulse 184 is longer in duration than the high voltage pulse 182, and its high state maintains the output of OR gate 151 continuously high, thereby maintaining power switch 154 closed and the low voltage bus continuously connected to the solenoid coil 28. Therefore, the current in the solenoid coil 28 continues as shown at 198 in FIG. 4 until the pull-in timer 102 expires. At that point, the current in the coil is at its peak value as shown at 191 in FIG. 4. As will be appreciated, using the high voltage pulse, the pull-in current will reach its desired value faster than without the high voltage pulse, and therefore, the duration of the pull-in pulse can be shorter when using the high voltage pulse. Thereafter, this embodiment of the voltage mode control operates identically as previously described with respect to the first embodiment of the voltage mode control.

Thus, the gun driver 84 has numerous advantages over known gun drivers. For example, gun driver 84 provides a single unit that can be used to provide either current control or voltage control when multiple dispensing valves are being used. Also, when using either current control or voltage control, the dispensing valve 20 is closed by applying a high voltage substantially greater than line voltages often used with known gun drivers. The high voltage is regulated thus providing a consistent and fast current slew rate to initially cause the valve to open.

Further, when using the current mode control, in the transition from the pull-in current to the hold current, a flyback mode can be used in which the flyback voltage is clamped to the high voltage bus; and the current from the back EMF is used to charge capacitor 172. Thus, that current is stored for subsequent use and is not dissipated as heat as is done in known systems. The current in the coil is reduced rapidly and consistently to its desired value. Similarly, regardless of the control mode, at the end of the dispensing cycle, the flyback voltage is clamped to the high voltage bus; and the current from the back EMF is used to charge capacitor 172.

In the current control mode, the pull-in and hold currents are maintained by applying a low voltage bus 156 to the coil 28 via a hysteresis modulation that provides a highly regulated, low amplitude ripple current. The low voltage bus is more energy efficient and provides better current regulation than known line voltage modulation systems.

The capacitor 172 is used as the sole high voltage power supply 88. In some applications, the capacitor 172 can be charged solely by the back EMF from the coil 28. In other applications, during the time that the dispensing valve 20 is off between actuations, the system control 94 can provide signals causing the gun driver 84 to intermittently pulse the dispensing valve 20 with the low voltage bus 156 by simultaneously closing and opening switches 134 and 154. That is, the low voltage bus 156 is applied to the dispensing valve coil 28 for sufficiently short pulse durations that current flows but the valve stem 22 does not move. Thus, the capacitor 172 can be charged sufficiently by the flyback of the coil 28 to function as the high voltage power supply 88. However, as will be appreciated, in still further applications, a power supply (not shown) can be optionally used to maintain a charge on the capacitor 172.

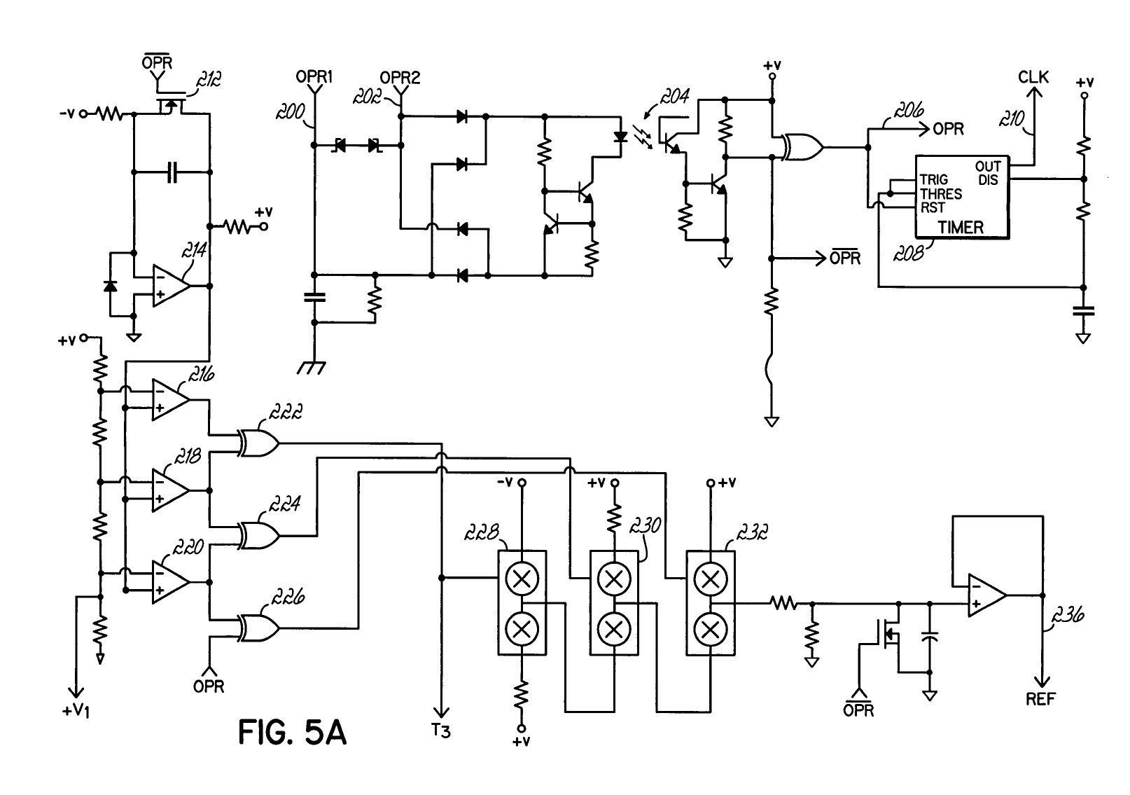

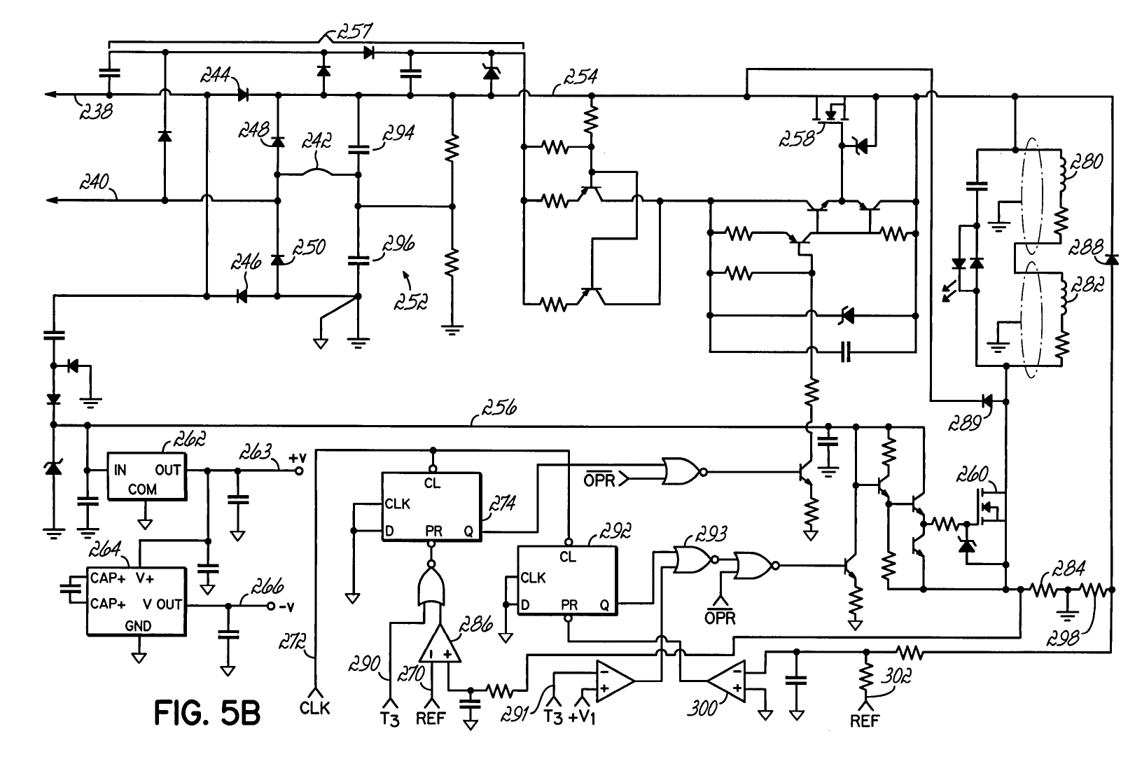

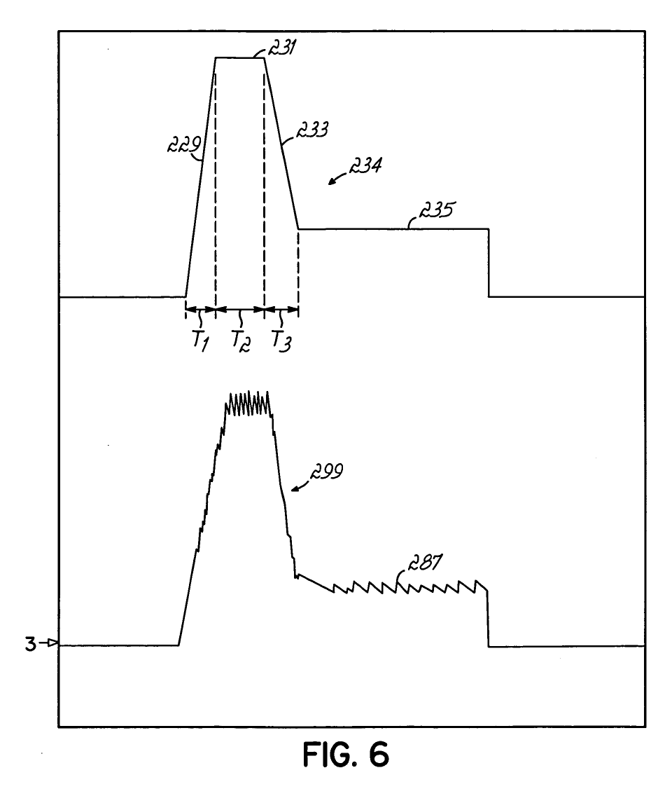

A second embodiment of a switch mode gun driver is illustrated in FIGS. 5A and 5B. Referring to the timer portion of the driver circuit in FIG. 5A, operator commands to initiate a fluid dispensing operation are received on inputs 200, 202 and passed through an optically coupled isolator 204. An operate command is provided on output 206 and is used to reset a timer 208 providing a clock signal on output 210. The operate command further toggles a switch 212 that enables a ramp generator 214. Comparators 216, 218 and 220 along with respective exclusive OR gates 222, 224, 226 and linear switches 228, 230, 232 provide, on output 236, a reference current waveform 234 shown in FIG. 6, which replicates an ideal gun current versus time profile. A first or pull-in phase of the current waveform 234 is shaped by three timing pulses T₁, T₂, T₃, that determine the duration of a ramp-up current reference 229, a pull-in current reference 231, and ramp-down current reference 233 to a hold current reference 235.

The driver portion of the switch mode gun driver is illustrated in FIG. 5B and has inputs 238, 240 connected to an unregulated line power source. A jumper 242 is installed when the inputs 238, 240 are connected to 120 Volts AC, and the diodes 244, 246, 248, 250 function as a voltage doubler. The jumper 244 is removed when the inputs 238, 240 are connected to 240 Volts AC. With the jumper 242 removed, the diodes 244, 246, 248, 250 are connected in a bridge-rectifier configuration. A voltage of about +330 volts is provided on bus 254, and a voltage of about +10 volts is provided on bus 256. A circuit 257 provides a voltage higher than the voltage bus 254, which powers the gate-drive circuits of the high side switch 258, and the voltage on bus 256 powers the gate-drive circuits of the low side switch 260. The voltage bus 256 also powers a voltage regulator that provides a positive voltage rail 263, and a charge-pump 264 provides a corresponding negative voltage rail 266.

A clock pulse on line 272 clears flip-flop 274 and drives its Q output low, which results in the high side switch 258 closing, thereby applying the voltage bus 254 to the solenoid coils 280, 282 within the fluid dispenser. The clock pulse on input 272 also clears the flip-flop 292 and drives its Q output low, which causes the low side switch 260 to close. Current flow through the coils 280, 282 has a path through the low side switch 260 and is monitored by a current sensing resistor 284. A comparator 286 compares the voltage from the current sensing resistor with the current waveform 234 being received on input 270. When the feedback voltage exceeds the reference on input 270, the flip-flop 274 is preset, thereby opening the high side switch 258 and removing the voltage bus from the coils 280, 282. Current caused by the back EMF of the coils 280, 282 flies back through diode 288. The current feedback voltage is now less that the increasing current waveform, thereby causing the comparator 286 to remove the preset from flip-flop 274.

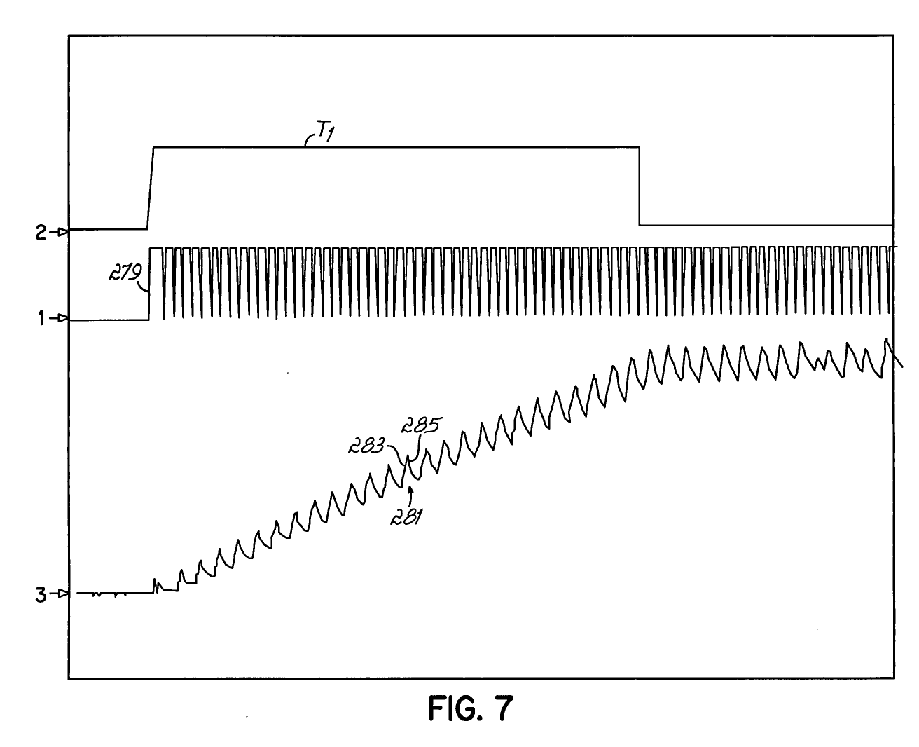

This process is shown graphically in FIG. 7 in which a waveform 281 of current in the coils during a ramp-up portion T₁ of the current waveform 234 is shown. An edge of one of the clock pulses 279 on input 272 clears the flip-flop 274 to provide an output that closes the high side switch 258 to apply the voltage bus 234 to the coils 280, 282, thereby increasing current flow in the coil as typically shown at 283. When the current feedback from sensing resistor 284 exceeds the ramp-up current reference, flip-flop 274 is preset, thereby opening the high side switch 258. The current in the coils 280, 282 freewheels downward as typically shown at 285. If, when a clock pulse is applied to the flip-flop 274, the feedback voltage still exceeds the ramp-up current reference 270, the flip-flop 274 is maintained in its preset state.

This process of applying and removing the voltage bus 234 from the coils 280, 282 continues for the duration of ramp-up current reference timing pulse T₁ as well as the pull-in current reference timing pulse T₂, that is, during the ramp-up and pull-in phases. During the timing pulse T₁, the ramp-up current reference waveform 229 on line 270 continuously increases until the desired pull-in current magnitude is reached. At that point, the timing pulse T₂ is initiated and the pull-in current reference waveform 231 on input 270 maintains a constant magnitude equal to the desired pull-in current. At the end of the pull-in phase, the timing pulse T₃ initiates a ramp-down phase in which the ramp-down current reference waveform 233 on input 270 decreases to a hold current reference magnitude.

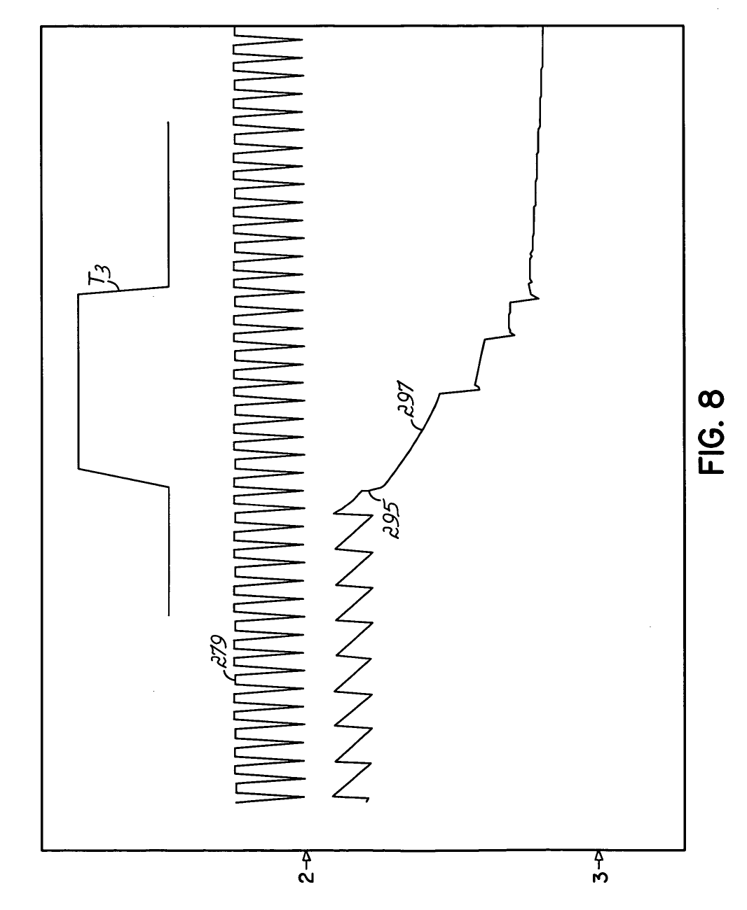

The timing pulse T₃ on input 290 maintains the flip-flop 274 preset and thus, the high side switch 258 is held open. Further, a clock pulse on input 272 drives the Q output low, which in combination with the timing pulse T₃ on input 291, provides an output that causes the low side switch 260 to open. As the ramp-down current reference waveform 233 decreases to the hold current reference value 235, the flyback current from the coils 280, 282 passes through a current sensing resistor 298 that provides a feedback voltage to comparator 300. Flyback current also flows through diodes 288, 289, thereby returning inductive energy to power supply capacitors 294, 296. As the coil current drops rapidly as shown typically in FIG. 8 at 295, the current sensing resistor 298 continues to provide current feedback to comparator 300. When the current feedback drops below the ramp-down current reference 233 on input 302, the comparator 300 changes state and presets the flip-flop 292, thereby closing the low side switch 260. Current is switched into the free-wheel mode via diode 288, thereby reducing the rate of current decay as shown typically at 297 of FIG. 7. As the rate of current decay is decreased, the current feedback exceeds the ramp-down current reference 233 on input 302, thereby changing the state of comparator 300 and removing the preset from flip-flop 292. The next clock pulse on input 272 clears flip-flop 292, which again causes the low side switch 260 to open, thereby again providing a flyback current to power supply capacitors 294, 296. With this cycle, the low side switch 260 is pulse width modulated to reduce the current in a rapid but controlled manner conforming to the ramp-down current reference waveform 233 until the remaining inductive energy stored in the coils 280, 282 is returned to the power supply. At the end of timing pulse T₃, the low side switch is again maintained closed, and the high side switch operates with the hold current reference waveform 235 to maintain a current through the coil as typically shown at 287 in FIG. 6.

With this switch mode gun driver, the instantaneous gun current is monitored and compared with the current waveform 234 replicating an ideal current versus time profile. Based on this comparison, the duty cycle of a pulse-width modulator implemented with the flip-flop 292 is varied to correct for current errors caused by line voltage variations, power supply ripple, gun inductance and gun resistance. Thus, the time-average voltage applied to the gun is controlled by a pulse-width modulation of the unregulated voltage. As shown in FIG. 6, the switch mode gun driver of FIGS. 5A and 5B is operative to provide a current flow in the coils 280, 282 as shown at 299 of FIG. 6 that closely approximates the current waveform 234.

The switch mode gun driver of FIGS. 5A and 5B has the advantage of being powered by a rectified, unregulated line-voltage in a way that improves power efficiency, reduces self-heating, improves reliability, permits more compact packaging and provides a more repeatable gun activation and hence, more repeatable valve opening and closing times. Further, using the gun winding as an inductive energy storage element eliminates the need for a custom designed magnetic component, which reduces manufacturing and inventory costs.

While the present invention has been illustrated by a description of various embodiments and while these embodiments have been described in considerable detail, it is not intended to restrict or in any way limit the scope of the appended claims to such detail. Additional advantages and modifications within the spirit and scope of the invention will readily appear to those skilled in the art. For example, referring to FIG. 1, the controller 92 is described as having operator inputs to select either a voltage or current control mode or a coast or flyback mode. As will be appreciated, in other embodiments, the selection of those modes is determined by the supplier of the controller 92 and is not available to the user. In the described embodiments, in both the current control mode and the voltage control mode, the leading edge of the trigger signal 100 causes both the high voltage bus 89 and the low voltage bus 156 to be applied to the solenoid coil 28. As will be appreciated, in an alternative embodiment, the application of the low voltage bus 156 can be delayed up until the time that the high voltage bus 89 is removed from the coil 28.

The gun drivers described herein are implemented in digital logic; however, as will be appreciated, in alternative embodiments, analog components may be used to implement various functions of the gun drivers. As will be appreciated, the values of the voltage bus magnitudes may be adjusted depending on the characteristics and performance of a particular dispensing gun and solenoid coil as well as the requirements of a dispensing pattern and cycle. Further, as will be appreciated, the features of the gun drivers described herein can be applied to both electric dispensing guns and pneumatically operated dispensing guns.

Therefore, the invention in its broadest aspects is not limited to the specific detail shown and described. Consequently, departures may be made from the details described herein without departing from the spirit and scope of the claims which follow.

1. A gun driver circuit for a fluid dispenser operable to dispense a fluid onto a substrate, the fluid dispenser having a dispensing valve operably connected to a solenoid coil, the solenoid coil being operable to cause the dispensing valve to move between open and closed positions for controlling a flow of the fluid from the fluid dispenser, the gun driver comprising:
a higher voltage bus;
a first switch having one side electrically connected to the higher voltage bus and a second side adapted to be connected to one end of the solenoid coil,
a second switch having one side adapted to be electrically connected to an opposite end of the solenoid coil;
a current sensor for sensing a current in the solenoid coil;
a lower voltage bus;
a third switch having one side electrically connected the lower voltage bus and a second side adapted to be in electrical communication with the one end of the solenoid coil; and
a control circuit operatively connected to the first switch, the second switch and the third switch, the control circuit
providing a pull-in current setpoint;
closing the first switch to apply the higher voltage bus to the solenoid coil and produce a current in the solenoid coil,
opening the first switch in response to the current in the coil being substantially equal to the pull-in current setpoint, and
operating the second switch to apply the lower voltage bus to the solenoid coil and maintain the current in the coil substantially equal to the pull-in current setpoint.

2. The gun driver of claim 1 wherein the control circuit closes the second switch substantially simultaneously with closing the first switch to connect the high voltage bus and the low voltage bus to the solenoid coil.

3. The gun driver of claim 1 wherein the high voltage bus comprises a capacitor.

4. The gun driver of claim 1 further comprising:
a first diode comprising a cathode connected to the higher voltage bus and an anode connected to the other end of the solenoid coil; and
a second diode comprising a cathode connected to the opposite end of the solenoid coil and an anode connected to the second side of the second switch.

5. The gun driver of claim 1 wherein the higher voltage bus provides a voltage higher than an available line voltage and the lower voltage bus provides a voltage less than the available line voltage.

6. The gun driver of claim 1 further comprising a third diode comprising a cathode connected to the one side of the third switch and an anode connected to the lower voltage bus.

7. A gun driver for a plurality of fluid dispensing guns operable to dispense a fluid onto a substrate, the fluid dispensing guns having a respective plurality of dispensing valves operably connected to a respective plurality of solenoid coils, each of the solenoid coils being operable to cause a respective dispensing valve to move between open and closed positions for controlling a flow of the fluid from a respective fluid dispensing gun, the gun driver comprising:
a voltage bus;
a power switching circuit having a first side connected to the voltage bus and a second side adapted to be electrically connected to at least one of the plurality of solenoid coils; and
a controller operatively connected to the power switching circuit to cause the power switching circuit to supply a pull-in current to the plurality of solenoid coils followed by a hold current, the controller comprising
a voltage mode control, the voltage mode control being used in response to the plurality of solenoid coils being connected in parallel across the voltage bus, and
a current mode control, the current mode control being used in response to the plurality of solenoid coils being connected in series with the voltage bus.

8. The gun driver of claim 7 further comprising a pull-in timer providing a signal representing a duration of a pull-in current.

9. The gun driver of claim 8 wherein the current mode control comprises:
a current sensor operatively connected with the plurality of solenoid coils to provide a feedback signal representing current in the plurality of solenoid coils; and
a comparator having a hysteresis value, the comparator comprising
a first input connected to the feedback signal,
a second input providing a current setpoint, and
an output connected to the power switching circuit, the comparator causing the power switching circuit to first, connect the voltage bus to the plurality of solenoid coils in response to the feedback signal being less than the current setpoint and second, disconnect the voltage bus from the plurality of solenoid coils in response to the feedback signal being greater than the current setpoint.

10. The gun driver of claim 9 wherein the current mode control further produces a pull-in current setpoint and a hold current setpoint, the pull-in current setpoint being used by the comparator for the duration of the pull-in current and the hold current setpoint being used by the comparator after the duration of the pull-in current.

11. The gun driver of claim 8 wherein the voltage mode control provides a voltage mode signal, and the voltage mode control causing the switching circuit to apply the voltage bus to the plurality of solenoid coils for the duration of the pull-in current.

12. The gun driver of claim 11 wherein the voltage mode control further comprises a pulse generator operatively connected to the power switching circuit, the pulse generator causing the power switching circuit to successively connect and disconnect the voltage bus to the plurality of solenoid coils after the duration of the pull-in current.

13. A fluid dispensing gun for dispensing a fluid onto a substrate comprising:
a dispensing valve movable between open and closed positions for controlling a flow of the fluid from said fluid dispensing gun;
a solenoid coil having a first end and a second end and being operable to cause the dispensing valve to move between the open and closed positions;
a higher voltage power supply comprising
a first terminal providing a higher voltage bus, and
a second terminal;
a first switch electrically connected between the first terminal of the higher voltage power supply and the first end of the solenoid coil;
a lower voltage power supply comprising
a first terminal providing a lower voltage bus, and
a second terminal, the second terminal having a common connection with the second terminal of the higher voltage power supply;
a second switch electrically connected between the lower voltage power supply and the first end of the solenoid coil;
a third switch electrically connected between the second end of the solenoid coil and the second terminal of the lower voltage power supply; and
a controller providing first, second and third output signals for operating the first, second and third switches, respectively, the control circuit further providing a stepped waveform comprising an initial pull-in phase followed by a lesser hold phase, the control circuit providing
the first, second and third output signals to close the first switch, the second switch and the third switch and electrically connect the first end of the solenoid coil with the higher voltage bus and the lower voltage bus during an initial portion of the pull-in phase, and
thereafter, the second and third output signals to close the second switch and the third switch and electrically connect the first end of the solenoid coil with the lower voltage bus for a remainder of the pull-in phase.

14. A gun driver circuit for a fluid dispenser operable to dispense a fluid onto a substrate, the fluid dispenser having a dispensing valve operably connected to a solenoid coil, the solenoid coil being operable to cause the dispensing valve to move between open and closed positions for controlling a flow of the fluid from the fluid dispenser, the gun driver comprising:
a rectified, unregulated voltage bus;
a first switching circuit having one side electrically connected to the unregulated voltage bus and a second side adapted to be connected to one end of the solenoid coil;
a current sensor for sensing a current in the solenoid coil;
and
a control circuit operatively connected to the current sensor and the first switching circuit, the control circuit comprising
a waveform generator providing a current reference waveform defining a ramp-up current reference, a pull-in current reference and a subsequent hold current reference, the control circuit operating the first switching circuit to create a current in the solenoid coil substantially equal to first, the ramp-up current reference and then, the pull-in current reference and thereafter, the hold current reference.

15. The gun driver circuit of claim 14 wherein the waveform generator further provides a ramp-down current reference between the pull-in current reference and the hold current reference, and the control circuit further comprises a second switching circuit connected to an opposite end of the solenoid coil, the second switching circuit having
a first state connecting a flyback current to the unregulated voltage bus in response to the first switching circuit disconnecting the solenoid coil from the unregulated voltage bus, and
a second state allowing the current in the solenoid coil to dissipate through a resistance in a circuit including the solenoid coil; and
the control circuit switching the second switching circuit between the first state and the second state to cause the current in the coil to be substantially equal to ramp-down current reference.

16. A gun driver circuit for a fluid dispenser operable to dispense a fluid onto a substrate, the fluid dispenser having a dispensing valve operably connected to a solenoid coil, the solenoid coil being operable to cause the dispensing valve to move between open and closed positions for controlling a flow of the fluid from the fluid dispenser, the gun driver comprising:
a rectified, unregulated voltage bus;
a first switching circuit having one side electrically connected to the unregulated voltage bus and a second side adapted to be connected to one end of the solenoid coil;
a current sensor for sensing a current in the solenoid coil;
a control circuit operatively connected to the current sensor and the first switching circuit, the control circuit comprising
a waveform generator providing a current reference waveform defining a pull-in current reference, a ramp-down current reference and a subsequent hold current reference, the control circuit operating the first switching circuit to create a current in the solenoid coil substantially equal to the current reference waveform; and
a second switching circuit connected to an opposite end of the solenoid coil, the second switching circuit having
a first state connecting a flyback current to the unregulated voltage bus in response to the first switching circuit disconnecting the solenoid coil from the unregulated voltage bus, and
a second state allowing the current in the solenoid coil to dissipate through a resistance in a circuit including the solenoid coil, the control circuit switching the second switching circuit between the first state and the second state to cause the current in the coil to be substantially equal to ramp-down current reference.

17. A method of operating a fluid dispensing gun for dispensing a fluid onto a substrate, the fluid dispensing gun having a dispensing valve operably connected to a solenoid coil, the solenoid coil being operable to cause the dispensing valve to move between open and closed positions for controlling a flow of the fluid from the fluid dispensing gun, the method comprising:
providing a pull-in phase duration, a pull-in current setpoint and a lesser hold current setpoint;
providing a higher voltage bus and a lower voltage bus;
applying the higher voltage bus to the solenoid coil during an initial portion of the pull-in phase duration to rapidly initiate a pull-in current through the solenoid coil;
removing the higher voltage bus from the solenoid coil in response to current in the solenoid coil being substantially equal to the pull-in current reference; and
applying the lower voltage bus to the solenoid coil to maintain a current in the solenoid coil substantially equal to the pull-in current reference.

18. The method of claim 17 further comprising modulating the application of the lower voltage bus to the solenoid coil to provide a ripple current substantially equal to the pull-in current reference.

19. The method of claim 17 further comprising applying the lower voltage bus to the solenoid coil during the initial portion of the pull-in phase.

20. The method of claim 17 further comprising removing the lower voltage bus from the solenoid coil at an end of the pull-in phase duration.

21. The method of claim 20 further comprising, in response to removing the lower voltage bus from the solenoid coil, clamping a flyback current from the solenoid coil to the higher voltage bus.

22. The method of claim 17 further comprising charging a capacitor providing the higher voltage bus with the flyback current resulting from a removal of the lower voltage.

23. The method of claim 17 further comprising modulating the application of the lower voltage bus to the solenoid coil to provide a ripple current to maintain current in the solenoid coil substantially equal to the hold current reference.

24. A method of operating a plurality of fluid dispensing guns for dispensing a fluid onto a substrate, the plurality of fluid dispensing guns having a respective plurality of dispensing valves operably connected to a respective plurality of solenoid coils, each of the solenoid coils being operable to cause a respective dispensing valve to move between open and closed positions for controlling a flow of the fluid from a respective fluid dispensing gun, the method comprising:
providing a voltage bus;
generating a timing signal representing a duration of a pull-in current phase;
generating a voltage mode signal, the voltage mode being used in response to the plurality of solenoid coils being connected in parallel across the voltage bus;
generating a current mode control signal, the current mode control being used in response to the plurality of solenoid coils being connected in series with the voltage bus; and
operating a power switching circuit connected between the voltage bus and the plurality of solenoid coils in response to the timing signal, the voltage mode control signal and the current mode control signal.

25. The method of claim 24 further comprising:
generating in response to the current mode signal a feedback signal representing current in the plurality of solenoid coils;
producing a current setpoint;
comparing with a hysteresis value the feedback signal and the current setpoint;
causing the power switching circuit to connect the voltage bus to the plurality of solenoid coils in response to the feedback signal being less than the current setpoint; and
causing the power switching circuit to disconnect the voltage bus from the plurality of solenoid coils in response to the feedback signal being greater than the current setpoint.

26. The method of claim 24 further comprising:
causing in response to the voltage mode control signal the power switching circuit to apply the voltage bus to the plurality of solenoid coils for the duration of the pull-in current phase;
detecting a current in one of the plurality of solenoid coils being substantially equal to the pull-in current setpoint;
thereafter generating a series of pulses; and
operating the power switching circuit with the series of pulses to successively connect and disconnect the voltage bus to the plurality of solenoid coils.

27. A method of operating a fluid dispensing gun for dispensing a fluid onto a substrate, the fluid dispensing gun having a dispensing valve operably connected to a solenoid coil, the solenoid coil being operable to cause the dispensing valve to move between open and closed positions for controlling a flow of the fluid from the fluid dispensing gun, the method comprising:
providing a rectified, unregulated voltage bus from a line voltage;
providing a switching circuit connected between the unregulated voltage bus and one end of the solenoid coil;
generating a current reference waveform representing a current versus time relationship defining a ramp-up current reference, a pull-in current reference and a subsequent hold current reference; and
operating the switching circuit to create a current in the solenoid coil substantially equal to the current reference waveform.

28. The method of claim 27 further comprising:
producing a current feedback signal representing the current in the solenoid coil; and
operating the switching circuit in response to the current reference waveform and the current feedback signal.

29. The method of claim 27 further comprising:
generating the current reference waveform comprising a ramp-down current reference between the pull-in current reference and the hold current reference;
providing a second switching circuit connected to an opposite end of the solenoid coil, the second switching circuit having
a first state connecting a flyback current to the unregulated voltage bus in response to the first switching circuit disconnecting the solenoid coil from the unregulated voltage bus, and
a second state allowing the current in the solenoid coil to dissipate through a resistance in a circuit including the solenoid coil; and
switching the second switching circuit between the first state and the second state to cause the current in the coil to be substantially equal to ramp-down current reference.

30. A method of operating a fluid dispensing gun for dispensing a fluid onto a substrate, the fluid dispensing gun having a dispensing valve operably connected to a solenoid coil, the solenoid coil being operable to cause the dispensing valve to move between open and closed positions for controlling a flow of the fluid from the fluid dispensing gun, the method comprising:
providing a rectified, unregulated voltage bus from a line voltage;
providing a first switching circuit connected between the unregulated voltage bus and the solenoid coil;
generating a current reference waveform representing a current versus time relationship defining a pull-in current reference, a ramp-down current reference and a subsequent hold current;
operating the first switching circuit to cause a current in the solenoid coil to substantially follow the pull-in current reference;
providing a second switching circuit connected to an opposite end of the solenoid coil, the second switching circuit having
a first state connecting a flyback current to the unregulated voltage bus in response to the first switching circuit disconnecting the solenoid coil from the unregulated voltage bus, and
a second state allowing the current in the solenoid coil to dissipate through a resistance in a circuit including the solenoid coil; and
switching the second switching circuit between the first state and the second state to cause the current in the solenoid coil to be substantially equal to ramp-down current reference.
